(19) United States
(12) Patent Application Publication
(10) Pub. No.: US 2023/0046555 A1
(43) Pub. Date: Feb. 16, 2023

(54) CLOTHES LINE HANDLING DEVICE

(71) Applicants: Alain Therrien, Terrebonne (CA); Kevin Therrien, Terrebonne (CA)

(72) Inventors: Alain Therrien, Terrebonne (CA); Kevin Therrien, Terrebonne (CA)

(21) Appl. No.: 17/819,165

(22) Filed: Aug. 11, 2022

(30) Foreign Application Priority Data
Aug. 13, 2021 (GB) 2111656.1

(51) Int. Cl. D06F 53/04; F16M 11/04; F16M 11/18; F16M 13/02

(52) U.S. Cl. CPC D06F 53/04; F16M 11/046; F16M 11/18; F16M 13/022

(57) ABSTRACT

A device for handling a clothes line, the device being mountable to a support, the device comprising: a body; a pulley mounted to the body for mounting the clothes line thereto; an elongated guide mountable substantially vertically to the support, the body being mounted to the guide and movable longitudinally therealong; and an actuating assembly operative for selectively moving the body along the guide and for selectively rotating the pulley to move the clothes line when the clothes line is also mounted to another pulley and looped around the two pulleys under tension.

### FIELD OF THE INVENTION

The present invention relates to the general field of clothes lines and, more particularly, to a clothes line handling device.

### BACKGROUND

Powered clothes line devices generally comprise a housing attached to a stationary support and an electrical motor in driving engagement with a clothes line pulley located inside the housing. The devices further generally comprise a break means for selectively immobilizing the clothes line and a control interface in the form of control buttons on the housing and/or on a remote handset or foot pedal.

While these known powered clothes line devices can generally fulfill the main objective of providing a means for effortlessly pulling and pushing on a clothes line, they generally do not allow a user to selectively adjust the vertical height of the device relative thereof so as to facilitate the manual operation of hanging and removing clothes on the line.

When present, the vertical adjustment capability of known powered clothes line devices, or any manually operated clothes lines for that matter, is generally realized through a separate means specifically adapted to fill this function. This means is generally represented for example by a manually operated cord and pulley system, or a powered device including its own housing, electrical motor, break means and control buttons.

Such vertical adjustment capability in a clothes line is highly desired by people having limitations or disabilities who want to remain autonomous at home. It is also desired by the public in general, since it can significantly facilitate the sometimes tiresome operation of hanging clothes to dry in the open air.

The additional cost of a powered device for raising and lowering a clothes line can be prohibitive for most people who cannot afford a conventional clothes dryer, and a manually operated cord and pulley system is generally not acceptable to someone having physical disabilities.

Thus, there is a need on the market for an improved device that avoids the aforementioned disadvantages. An object of the present invention is therefore to provides such an improved device.

### SUMMARY OF THE INVENTION

In a broad aspect, there is provided a device for handling a clothes line, the device being mountable to a support, the device comprising: a body; a pulley mounted to the body for mounting the clothes line thereto; an elongated guide mountable substantially vertically to the support, the body being mounted to the guide and movable longitudinally therealong; and an actuating assembly operative for selectively moving the body along the guide and for selectively rotating the pulley to move the clothes line when the clothes line is also mounted to another pulley and looped around the two pulleys under tension.

There may also be provided a device wherein the actuating assembly includes first and second worm drives operative respectively for rotating the pulley and moving the body along the guide.

There may also be provided a device wherein the actuating assembly includes a motor and a drive shaft operatively coupled to the motor for being rotated thereby, the drive shaft being configured for selectively alternatively engaging the first and the second worm drives.

There may also be provided a device wherein the first and second worm drives include respectively a first worm screw meshing with a first worm gear and a second worm screw meshing with a second worm gear, the first worm drive being configured so that rotating the first worm screw results in rotation of the pulley, and the second worm drive being configured so that rotating the second worm screw results in movements of the body along the guide.

There may also be provided a device wherein the drive shaft is movable between drive shaft first and second positions wherein the drive shaft respectively engages the first and second worm screws so as to be jointly axially rotatable therewith and is disengaged respectively from the second and first worm screws so as to be freely rotatable relative thereto.

There may also be provided a device wherein the first and second worm screws define respectively axial first and second worm passageways, the drive shaft extending through the first and second worm passageways so as to be freely rotatable relative thereto, the drive shaft being provided with first and second engagement gears at longitudinally spaced apart locations therealong and jointly rotatable therewith, the first and second engagement gears being configured and sized for engaging respectively first and second internal gears provided in the first and second worm passageways when the drive shaft is respectively in the drive shaft first and second positions so that the drive shaft and an engaged worm screw from the first and second worm screws engaged by one of the first and second engagement gears are jointly rotatable.

There may also be provided a device further comprising a drive shaft actuator for selectively moving the drive shaft between the drive shaft first and second positions.

There may also be provided a device further comprising a controller and a user interface operatively coupled thereto for sending user selected commands thereto, the user interface including clothes line controls for commanding rotations of the pulley and height controls for commanding movements of the body along the guide, the controller being operative for controlling the drive shaft actuator so that the drive shaft is in the drive shaft first position when the clothes line controls are activated and the drive shaft is in the drive shaft second position when the height controls are activated; and controlling the motor so that the motor is energized to rotate in a predetermined direction resulting in a selected rotation of the pulley or a selected movement of the body along the guide when respectively one of the clothes line or height controls is selected.

There may also be provided a device wherein the user interface includes push buttons mounted to the body.

There may also be provided a device wherein the user interface includes a remote control physically spaced apart from the body.

There may also be provided a device wherein the drive shaft is telescopically mounted to an output shaft of the motor so as to be jointly rotatable therewith while being longitudinally movable relative thereto.

There may also be provided a device wherein the guide includes a rack and the second worm screw acts as a pinion engaging the rack.

There may also be provided a device wherein the pulley is mounted inside the body, the body defining a pair of clothes line apertures for receiving the clothes line therethrough.

There may also be provided a device wherein the body is provided with rollers adjacent the clothes line apertures for abutting against the clothes line and facilitating movements of the clothes line relative to the body.

There may also be provided a device further comprising height limiters operative for limiting movements of the body along the guide within a predetermined range of positions therealong.

There may also be provided a device wherein the height limiters include protrusions interfering mechanically with movements of the body along the guide.

There may also be provided a device wherein the height limiters includes limit switches operative for shutting down the actuating assembly when the body reaches an extremity of the predetermined range of positions.

There may also be provided a device wherein the clothes line includes an inline element protruding radially relative thereto, the device further comprising a clothes line movement limiter operative for limiting movements of the clothes line along the guide so that the clothes line stops moving if the inline element is within a predetermined distance of the body.

There may also be provided a device wherein the guide includes a pair of laterally opposed rails engaged by the body, the body being movable along the rails.

In another broad aspect, there is provided a clothes line assembly mountable to first and second spaced apart supports, the clothes line assembly comprising: a clothes line; a first pulley mountable to the first support so as to be rotatable relative thereto; a body; a second pulley mounted to the body, the clothes line being looped around the first and second pulleys; an elongated guide mountable substantially vertically to the second support, the body being mounted to the guide so as to be movable therealong; and an actuating assembly operative for selectively rotating the second pulley to move the clothes line therealong and for selectively moving the body along the guide.

An advantage of some embodiments of the present invention resides in that, when the motor is not actuated, the first and second worm gear drives maintain the vertical position of the drive unit and the position of the clothes line without the need for the additional cost of a locking break means.

Also, due to the use of a single motor to both move the clothes line and adjust its height, the present invention may be produced at a substantially low cost so as to be affordable to most people having a low income, which is often the case for people having one or more physical limitations or disabilities who want to remain autonomous at home.

The proposed devices allows one to both vary the height of a clothes line and push and pull the clothes line using a single compact and ergonomic device that may be manufactured relatively inexpensively.

The present application claims priority from UK patent application 2111656.1 filed Aug. 13, 2021, the contents of which is hereby incorporated by reference in its entirety.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a perspective view, illustrates an embodiment of a clothes line handling device, according to the present invention, here shown attached to a stationary support exemplified by a vertical post;

FIG. 2, in an exploded perspective view, illustrates the clothes line handling device of FIG. 1;

FIG. 3, in a perspective view, illustrates an embodiment of a handheld wireless remote controller usable with the clothes line handling device of FIG. 1;

FIG. 4, in a perspective view, illustrates an embodiment of a wireless remote controller in the form of a foot pedal usable with the clothes line handling device of FIG. 1;

FIG. 5, in a partial side cutaway view, illustrates an embodiment of an actuating assembly part of the device of FIG. 1, here shown with a drive shaft thereof in a drive shaft second position allowing the clothes line to be selectively raised and lowered relative to a stationary support;

FIG. 6, in a partial side cutaway view, illustrates the actuating assembly of FIG. 5, here shown with the drive shaft in a drive shaft first position allowing the clothes line to have a lower segment thereof to be selectively pulled towards or pushed away from the stationary support;

FIG. 7, in a side elevational view with parts removed, illustrates the clothes line handling device of FIG. 1; and

FIG. 8, in a side elevational view with parts removed, illustrates an alternative embodiment of a clothes line handling device.

### DETAILED DESCRIPTION

The terms “substantially” and “about” are used throughout this document to indicate variations in the thus qualified terms. These variations are variations that do not materially affect the manner in which the invention works and can be due, for example, to uncertainty in manufacturing processes or to small deviations from a nominal value or ideal shape that do not cause significant changes to the invention. Also, directional terminology, such as “vertical”, is used with reference to a typical use of the proposed device. This terminology is used for convenience and should not be used to unduly restrict the scope of the present invention.

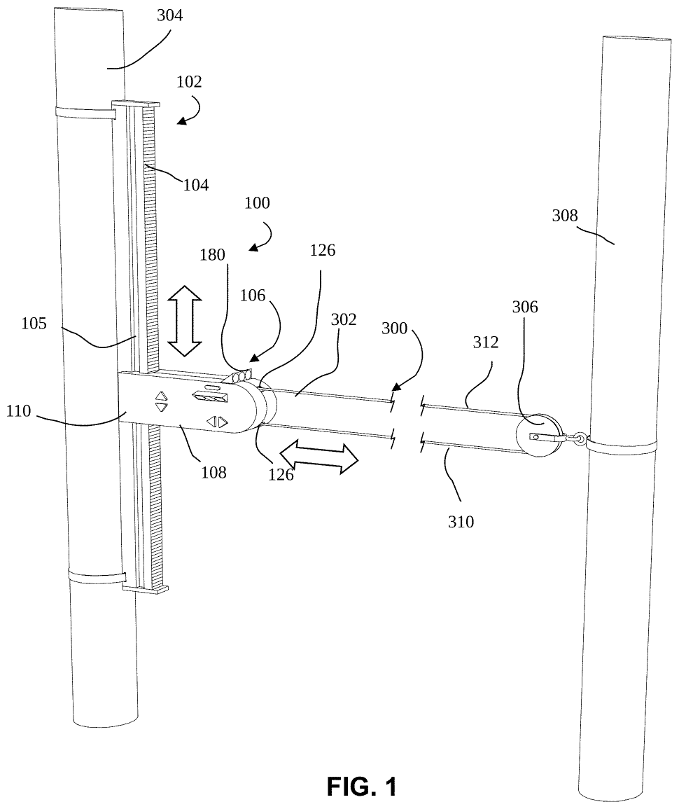

FIG. 1 illustrates various aspects of an embodiment, according to the present invention, of a clothes line handling device 100 capable of allowing a user to operate the rotation of a clothes line 300 about support pulleys, as well as raising and lowering one end of the clothes line 300 so as to facilitate hanging and retrieving laundry thereon and therefrom.

The device 100 is usable with a conventional clothes line 300 having an elongated loop configuration having a proximal end 302 thereof located adjacently a first stationary support 304, and a distal end thereof engaged on a distal clothes line pulley 306 rotatably mounted to a second stationary support 308 spaced apart from the first stationary support 304. The clothes line 300 includes a lower portion 310 to which clothes and other items can be hanged, and an upper portion 312 completing the loop formed by the clothes line 300.

The device 100 includes an elongated guide 102. The guide 102 is attached to the first stationary support 304 and extends typically substantially vertically, generally transversally relative to the elongated loop configuration of the clothes line 300. Furthermore, the elongated guide 102 defines a pair of laterally opposed rails 105 extending longitudinally therealong and a toothed rack 104 provided between the rails 105 and typically facing outwardly relative to the first stationary support 304. The first stationary support 304 may take the form of a vertical post, as illustrated in FIG. 1, of a wall, or any other suitable stationary structure.

The device 100 further comprises a drive unit 106. The drive unit 106 includes a body 108, which for example forms a housing receiving an actuating assembly including components used to handle the clothes line 300. The body 108 is mounted to the guide 102 and movable longitudinally therealong. For example, the body 108 is movable along the rails 105 and includes a rail engaging portion 110 engaging the rails 105 so that the only degree of freedom of the body 108 relative to the rail 105 is the translation motion along the guide 102. If needed, bearings, rollers or other structures are provided to facilitate translation of the body 108 along the guide 102, but a simple sliding motion is also possible.

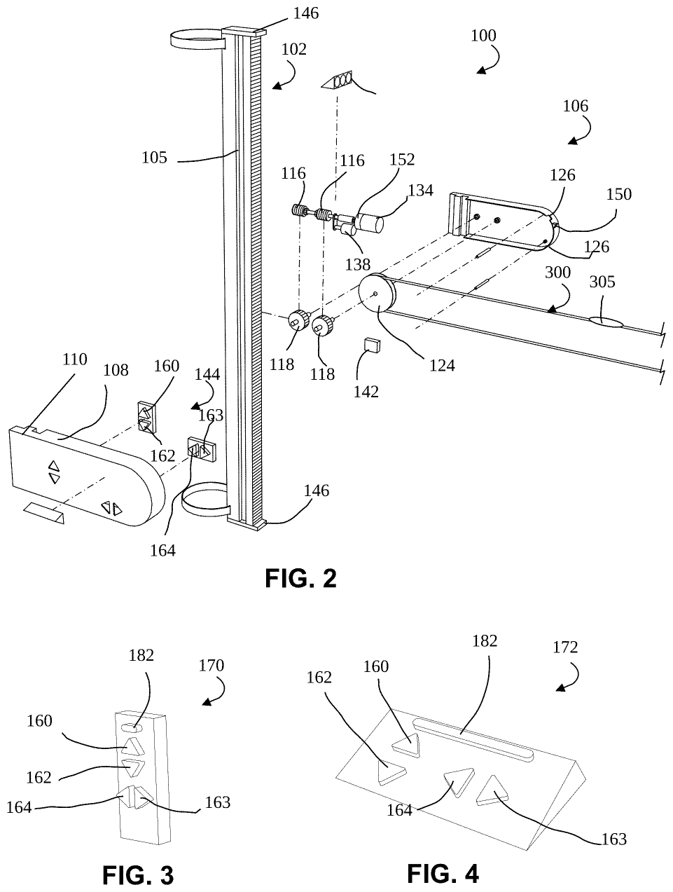

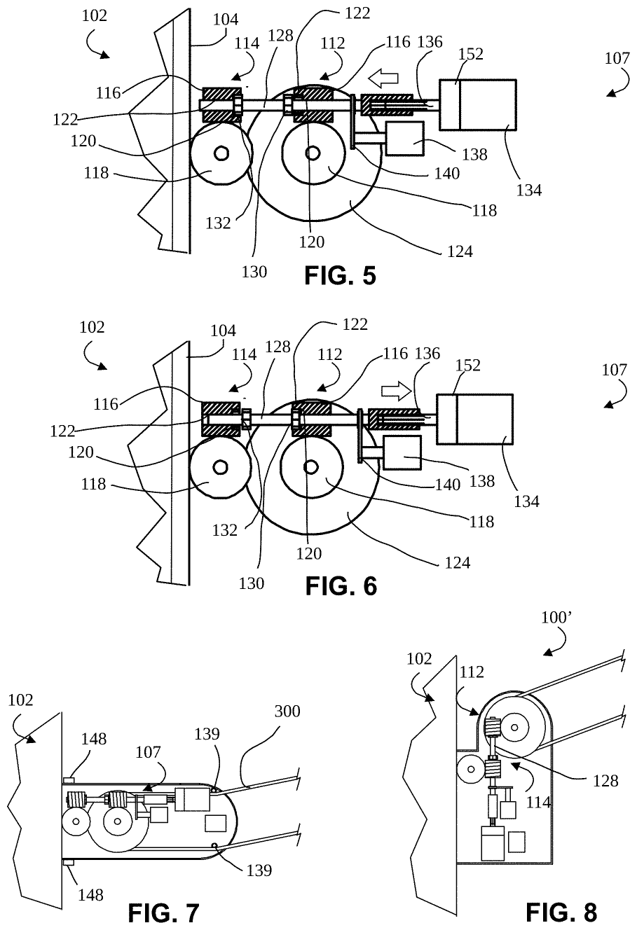

Referring now collectively to FIGS. 2, 5 and 6, the drive unit 106 further includes a pulley 124 mounted to the body 108 for mounting the clothes line 300 thereto and an actuating assembly 107 operative for selectively moving the body 108 along the guide 102 and for selectively rotating the pulley 124 to move the clothes line 300 when the clothes line 300 is also mounted to another pulley 306 and looped around the two pulleys 124 and 306 under tension.

The actuating assembly includes first and second worm drives 112 and 114 operative respectively for rotating the pulley 124 and moving the body 108 along the guide 102. Each one of the first and second worm drives 112 and 114 is located within the body 108 and includes a worm screw 116 having an outer peripheral portion thereof in driving engagement with a worm gear 118 rotatably mounted within the body 108. The first worm drive 112 is configured so that rotating its worm screw 116 results in rotation of the pulley 124, and the second worm drive 114 is configured so that rotating its worm screw 116 results in movements of the body 108 along the guide 102.

The worm screws 116 are located longitudinally spaced apart from each other coaxially in register relative to each other along a common axis and each define a worm passageway 122 extending longitudinally axially therethrough The worm passageways 122 define each an internal gear 120 at ends thereof that are facing each other.

In a typical arrangement, the worm gear 118 of the second worm drive 114 forms a pinion that has a peripheral portion thereof in driving engagement with the rack 104, forming a rack and pinion arrangement. Also, the pulley 124 is typically parallelly coupled on a same rotational axis of the worm gear 118 of the first worm drive 112 and engages the proximal end 302 of the elongated loop configuration of the clothes line 300 (as best illustrated in FIG. 2). The clothes line 300 extends through the body 108 through suitably sized apertures 126. If required, additional gears or gear boxes may be provided between the first and second worm drives 112 and 114 and respectively the pulley 124 and the rack 104 to provide suitable movement speeds.

The drive unit 106 further includes an elongated drive shaft 128 extending longitudinally slidably through each one of the worm passageways 122 coaxially in register with the common axis thereof. The drive shaft 128 is configured for being able to selectively alternatively engage the first and the second worm drives 112 and 114. To that effect, the drive shaft 128 extends through the worm passageways 122 so that a main shaft portion thereof is freely rotatable relative thereto. Furthermore, the drive shaft 128 is provided with first and second engagement gears 130 and 132 protruding radially from the main shaft portion at longitudinally spaced apart locations therealong and jointly rotatable therewith.

The drive shaft 128 is movable between drive shaft first and second positions wherein the drive shaft 128 respectively engages the worm screws 116 of the first and second worm drives 112 and 114 so as to be jointly axially rotatable therewith and is disengaged respectively from the second and first worm drives 114 and 112. More specifically, the first and second engagement gears 130 and 132 are configured and sized for engaging only one of the internal gears 120 provided in the first and second worm drives 112 and 114 when the drive shaft 128 is respectively in the drive shaft first and second positions so that the drive shaft 128 and an engaged worm screw 116 from the first and second worm drives 112 and 114 engaged by one of the first and second engagement gears 130 and 132 are jointly rotatable.

The drive unit 106 further includes a bidirectional electric motor unit 134 located within the body 108 and having an output shaft 136 adapted to be in rotational driving engagement with the drive shaft 128 when the latter is in the drive shaft first and second positions.

The drive unit 106 further includes a drive shaft actuator 138, for example in the form of a solenoid actuator, located within the body 108 and having an actuator member 140 connected to the drive shaft 128. The actuator member 140 is adapted for moving the drive shaft 128 longitudinally axially between the drive shaft first and second positions.

Thus, when the drive shaft 128 is in the drive shaft first position, the first engagement gear 130 is slidably engaged in the internal gear 120 of the first worm drive 112, while the second engagement gear 132 is longitudinally away from any one of the internal gears 120. When the drive shaft 128 is in the drive shaft second position, the first engagement gear 130 is longitudinally away from any one of the internal gears 120, while the second engagement gear 132 is slidably engaged in the internal gear 120 of the second worm drive 114.

Referring collectively to FIGS. 2, 3 and 4, the drive unit 106 further includes a controller 142 electrically coupled with an electrical power source (not shown in the drawings), the motor unit 134 and the drive shaft actuator 138 through suitable wires (not shown in the drawings). Furthermore, the controller 142 is adapted for selectively receiving upward, downward, forward and reverse command signals. The drive unit 106 further includes a user control interface 144 operatively coupled with the controller 142 for allowing a user to selectively actuate the upward, downward, forward and reverse command signals of the controller 142.

When the controller 142 receives one of an upward or downward command signal from the user control interface 144, through height controls, the controller 142 actuates the drive shaft actuator 138 so as to move the drive shaft 128 in the drive shaft second position followed with actuating the motor unit 134 in a corresponding direction relative to the command signal.

When the controller 142 receives one of a forward or reverse command signal from the user control interface 144, through clothes line controls, the controller 142 actuates the drive shaft actuator 138 so as to moves the drive shaft 128 in the drive shaft first position followed with actuating the motor unit 134 in a corresponding direction relative to the command signal.

Thus, through the user control interface 144, a user may selectively command the drive unit 106 to move upwardly or downwardly relative to the rack 104 so as to have the clothes line 300 at a desired height, as well as rotate the clothes line 300 in a forward or reverse direction so as to hang garments to dry in the open air and retrieve the latter's once dry.

An advantage of the present invention resides in that, when the motor unit 134 is not actuated, the first and second worm drives 112 and 114, maintain the vertical position of the drive unit 106 and the position of the clothes line 300 without the need for the additional cost of a locking break means. Thus, the present invention may be produced at a substantially low cost so as to be affordable to most people having a low income, which is often the case for people having one or more physical limitations or disabilities who want to remain autonomous at home.

In some embodiments of the device 100, according to the present invention, the rotational axis of the worm screws 116 and the worm gears 118 are at right angle relative to one another.

In some embodiments, the output shaft 136 of the motor unit 134 has an end portion thereof coaxially longitudinally align in register at one end of the drive shaft 128. The end portion of the output shaft 136 is slidably engaged with the drive shaft 128 through a telescopic arrangement adapted to allow the motor unit 134 to rotationally drive the drive shaft 128 when the latter is in the first and second position thereof.

In the embodiment shown in FIGS. 1, 2, 5, 6 and 7, the drive shaft 128 is substantially perpendicular to the guide 102. In alternative embodiments, such as in the device 100′ seen in FIG. 8, the drive shaft 128 is substantially parallel to the guide 102.

In some embodiments, the device 100 further includes height limiters 146 operative for limiting movements of the body 108 along the guide 102 within a predetermined range of positions therealong. The height limiters 146 are for example configured for stopping the translation movement of the body 108 along the guide 102 between upper and lower limits of travel.

In some embodiments, the height limiters 146 includes protrusions interfering mechanically with movements of the body along the guide 102. For example, each protrusion is located substantially adjacently a respective longitudinal end of the rack 104 and is adapted for abuttingly stopping the travel of the drive unit 106.

In some embodiments (not shown in the figures), each protrusion is positionable at a user selected location along the guide 102 so as to define custom upper and lower limits of travel of the drive unit 106 therealong. Referring to FIG. 7, in some embodiments, the height limiters includes limit switches 148 operative for shutting down the actuating assembly 107 when engaging the protrusions. Other known height limiters are also possible.

Referring to FIG. 2, in some embodiments, the device 100 further includes a clothes line movement limiter 150 configured for stopping the rotation of the motor unit 134 and, thus, the rotation of the clothes line 300 under predetermined conditions.

For example, the clothes line movement limiter 150 may include a limit switch mounted to the body 108 so as to be located proximally the clothes line 300, and electrically coupled to the controller 142. Furthermore, the clothes line movement limiter 150 and the controller 142 are adapted for stopping the motor unit 134 when detecting a clothes line inline element 305 attached at a suitable location along the clothes line 300. Such clothes line inline elements 305 may be represented by a clothes line spring or tightening element often inserted serially along conventional clothes lines 300 and protruding radially from the remainder of the clothes line 300.

Referring to FIGS. 2 to 4, in some embodiments, the motor unit 134 includes a gearbox 152 having a suitable gear ratio such that the motor unit 134 actuates the clothes line 300 fully loaded with wet laundry at a reasonable speed and power for a user.

In some embodiments, the electrical power source is selected from one of a rechargeable battery and a power outlet through a flexible power cord having a sufficient length.

Referring to FIGS. 2, 3 and 4, in some embodiments, the user control interface 144 includes a first, second, third and fourth control button 160, 162, 163 and 164, for selectively actuating the upward, downward, forward and reverse commands of the controller 142 respectively.

In some other embodiments, as illustrated in FIGS. 3 and 4 respectively, the user control interface 144 includes one of a handheld remote control unit 170, and foot pedal remote control unit 172 physically spaced apart from the body and operatively coupled with the controller 142 through one of a wired and a wireless connection.

Referring to FIG. 7, in some embodiments, the drive unit 106 further includes at least one clothes line roller 139 located adjacent at least one of the apertures 126 of the housing through which the clothes line 300 extends, so as to allow the angle of the clothes line 300 to vary as the drive unit 106 is raised and lowered without entering in contact with edge portions of the apertures 126 and thus facilitate movements of the clothes line 300 relative to the body 108.

In some embodiments, each one of the first, second, third and fourth buttons 160, 162, 163 and 164 are variable potentiometer push buttons. Furthermore, the controller 142 is adapted to allow a user to actuate the motor unit 134 at a user selected speed corresponding to the pressure applied on the corresponding button.

In some embodiments, the device 100 further includes at least one lamp 180 electrically coupled to the power source through a lamp switch 182, the at least one lamp 180 being adapted for lighting at least one of a portion of the clothes line 300 adjacent the drive unit 106 and a portion of the floor on which is standing the user nearby the drive unit 106.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is:

1. A device for handling a clothes line, the device being mountable to a support, the device comprising:
a body;
a pulley mounted to the body for mounting the clothes line thereto;
an elongated guide mountable substantially vertically to the support, the body being mounted to the guide and movable longitudinally therealong; and
an actuating assembly operative for selectively moving the body along the guide and for selectively rotating the pulley to move the clothes line when the clothes line is also mounted to another pulley and looped around the two pulleys under tension.

2. The device as defined in claim 1, wherein the actuating assembly includes first and second worm drives operative respectively for rotating the pulley and moving the body along the guide.

3. The device as defined in claim 2, wherein the actuating assembly includes a motor and a drive shaft operatively coupled to the motor for being rotated thereby, the drive shaft being configured for selectively alternatively engaging the first and the second worm drives.

4. The device as defined in claim 3, wherein the first and second worm drives include respectively a first worm screw meshing with a first worm gear and a second worm screw meshing with a second worm gear, the first worm drive being configured so that rotating the first worm screw results in rotation of the pulley, and the second worm drive being configured so that rotating the second worm screw results in movements of the body along the guide.

5. The device as defined in claim 4, wherein the drive shaft is movable between drive shaft first and second positions wherein the drive shaft respectively engages the first and second worm screws so as to be jointly axially rotatable therewith and is disengaged respectively from the second and first worm screws so as to be freely rotatable relative thereto.

6. The device as defined in claim 5, wherein the first and second worm screws define respectively axial first and second worm passageways, the drive shaft extending through the first and second worm passageways so as to be freely rotatable relative thereto, the drive shaft being provided with first and second engagement gears at longitudinally spaced apart locations therealong and jointly rotatable therewith, the first and second engagement gears being configured and sized for engaging respectively first and second internal gears provided in the first and second worm passageways when the drive shaft is respectively in the drive shaft first and second positions so that the drive shaft and an engaged worm screw from the first and second worm screws engaged by one of the first and second engagement gears are jointly rotatable.

7. The device as defined in claim 6, further comprising a drive shaft actuator for selectively moving the drive shaft between the drive shaft first and second positions.

8. The device as defined in claim 7, further comprising a controller and a user interface operatively coupled thereto for sending user selected commands thereto, the user interface including clothes line controls for commanding rotations of the pulley and height controls for commanding movements of the body along the guide, the controller being operative for
controlling the drive shaft actuator so that the drive shaft is in the drive shaft first position when the clothes line controls are activated and the drive shaft is in the drive shaft second position when the height controls are activated;
controlling the motor so that the motor is energized to rotate in a predetermined direction resulting in a selected rotation of the pulley or a selected movement of the body along the guide when respectively one of the clothes line or height controls is selected.

9. The device as defined in claim 8, wherein the user interface includes push buttons mounted to the body.

10. The device as defined in claim 8, wherein the user interface includes a remote control physically spaced apart from the body.

11. The device as defined in claim 5, wherein the drive shaft is telescopically mounted to an output shaft of the motor so as to be jointly rotatable therewith while being longitudinally movable relative thereto.

12. The device as defined in claim 4, wherein the guide includes a rack and the second worm screw acts as a pinion engaging the rack.

13. The device as defined in claim 1, wherein the pulley is mounted inside the body, the body defining a pair of clothes line apertures for receiving the clothes line therethrough.

14. The device as defined in claim 13, wherein the body is provided with rollers adjacent the clothes line apertures for abutting against the clothes line and facilitating movements of the clothes line relative to the body.

15. The device as defined in claim 1, further comprising height limiters operative for limiting movements of the body along the guide within a predetermined range of positions therealong.

16. The device as defined in claim 15, wherein the height limiters include protrusions interfering mechanically with movements of the body along the guide.

17. The device as defined in claim 15, wherein the height limiters includes limit switches operative for shutting down the actuating assembly when the body reaches an extremity of the predetermined range of positions.

18. The device as defined in claim 1, wherein the clothes line includes an inline element protruding radially relative thereto, the device further comprising a clothes line movement limiter operative for limiting movements of the clothes line along the guide so that the clothes line stops moving if the inline element is within a predetermined distance of the body.

19. The device as defined in claim 1, wherein the guide includes a pair of laterally opposed rails engaged by the body, the body being movable along the rails.

20. A clothes line assembly mountable to first and second spaced apart supports, the clothes line assembly comprising:
a clothes line;
a first pulley mountable to the first support so as to be rotatable relative thereto;
a body;
a second pulley mounted to the body, the clothes line being looped around the first and second pulleys;
an elongated guide mountable substantially vertically to the second support, the body being mounted to the guide so as to be movable therealong; and
an actuating assembly operative for selectively rotating the second pulley to move the clothes line therealong and for selectively moving the body along the guide.
